(19) United States
(12) Patent Application Publication
(10) Pub. No.: US 2016/0233823 A1
(43) Pub. Date: Aug. 11, 2016

(54) SOLAR-MODULE FRAME PROFILE, SOLAR MODULE AND METHOD OF ADHESIVELY BONDING A SOLAR-MODULE FRAME PROFILE TO THE SOLAR-MODULE LAMINATE

(71) Applicant: HANWHA Q CELLS GMBH, Bitterfeld-Wolfen (DE)

(72) Inventors: Heiko MOLITOR, Hohenmolsen (DE); Marc DEWENTER, Halle (DE); Thomas EBENROTH, Bitterfeld-Wolfen (DE); Henning BUSSE, Leipzig (DE)

(21) Appl. No.: 15/040,695

(22) Filed: Feb. 10, 2016

(30) Foreign Application Priority Data
Feb. 11, 2015 (DE) 102015101957.4

(51) Int. Cl. H02S 30/10; B29C 65/00; B29C 65/48

(52) U.S. Cl. CPC H02S 30/10; B29C 65/48; B29C 66/12; B29L 2031/34

(57) ABSTRACT

A solar-module frame profile for framing a solar-module laminate. The solar-module frame profile has a frame groove formed from a front-side leg and a rear-side leg and a frame-groove crosspiece which spaces apart the front-side leg and the rear-side leg and from which the legs extend away laterally, forming the frame groove along an opening direction. The front-side leg has a front-side-leg end portion, which is spaced apart from the crosspiece, and a front-side-leg extent portion arranged between the frame-groove crosspiece and the end portion, and defines a front-side-adhesive-bonding plane for bonding the solar-module frame profile to the solar-module-laminate front side. The end portion projects out of the plane in the direction of the rear-side leg by an adhesive-bonding extent. The front-side leg has formed in it an adhesive cavity for accommodating adhesive beyond the adhesive-bonding extent, and/or the end portion has formed in it an adhesive cavity.

### PRIORITY CLAIM

The present application claims priority to German Patent Application No. 102015101957.4, filed on Feb. 11, 2015, which said application is incorporated by reference in its entirety herein.

### FIELD OF THE INVENTION

The invention relates to a solar-module frame profile, to a solar module and to a method of adhesively bonding a solar-module frame profile to a solar-module laminate. The solar-module frame profile currently being sold by the applicant is shown schematically, in partial cross section, in FIG. 1. This solar-module frame profile with a u-shaped frame groove is suitable for framing a solar-module laminate having a solar-module-laminate front side and a solar-module-laminate rear side.

### BACKGROUND OF THE INVENTION

Solar-module laminates are often designed in the form of a glass panel on which are arranged solar cells which are electrically wired in the form of so-called strings and have been laminated with embedding polymers and a plastic film which has long-term weather resistance. The glass panel forms the solar-module-laminate front side, and the weather-resistant plastic film forms the solar-module-laminate rear side. The solar-module laminate completed in this way can be adhesively bonded to the solar-module frame profile shown in FIG. 1, so that the stability and strength of said frame profile are increased and/or to create a means of installation via the frame profiles. The layered laminate structure which is made up of the glass panel, solar-cell strings, embedding polymers and weather-resistant plastic film and has not yet been combined with solar-module frame profiles is referred to, within the context of this invention, as solar-module laminate. As soon as this solar-module laminate is combined with a frame constructed from solar-module frame profiles, it is referred to as a solar module. The difference between the terms “solar module” and “solar-module laminate” resides in the fact that the solar module, in relation to the solar-module laminate, also has a solar-module frame and adhesive for adhesively bonding the solar-module frame to the solar module.

The solar-module frame profile shown in the form of a partial cross-sectional view in FIG. 1 has an essentially u-shaped frame groove which is formed: from a front-side leg 1 for engaging over the solar-module-laminate front side along a solar-module-laminate edge, from a rear-side leg 3 for engaging over the solar-module-laminate rear side along the solar-module-laminate edge, and from a frame-groove crosspiece 2, which spaces apart the front-side leg 1 and the rear-side leg 3 from one another and from which the front-side leg 1 and the rear-side leg 3 extend away laterally, forming the frame groove in doing so, along an opening direction 0. As seen in a cross section oriented perpendicularly to the plane of the solar-module laminate L and along the opening direction O, the front-side leg 1 has a front-side-leg end portion 11, which is spaced apart from the frame-groove crosspiece 2, and a front-side-leg extent portion 12, which is arranged between the frame-groove crosspiece 2 and the front-side-leg end portion 11 and defines a front-side-adhesive-bonding plane V for adhesively bonding the solar-module frame profile to the solar-module-laminate front side. The front-side-leg end portion 11 projects out of the front-side-adhesive-bonding plane V in the direction of the rear-side leg 3 by an adhesive-bonding extent K.

The solar-module laminate and the solar-module frame profile are provided so that the solar-module frame profile shown in FIG. 1 can be adhesively bonded to the solar-module laminate. An adhesive is applied, in the interior of the frame groove, to the frame-groove crosspiece 2 and, during the operation of the solar-module laminate and solar-module frame profile being pushed one inside the other, the adhesive is partially displaced along the front-side leg 1 and the rear-side leg 2, and it therefore extends in part along the front-side leg 1 and the rear-side leg 2. The front-side-leg end portion 11 is intended to prevent adhesive from exiting onto the solar-module-laminate front side, since this spoils the aesthetics and, in the extreme case, can also reduce efficiency, because incident sunlight, prior to coming into contact with the solar-module laminate, is attenuated. However, various material tolerances, for example solar-module-laminate thickness, solar-module dimensions, solar-module frame profile lengths, and process tolerances, for example the framing stations used in the form of partly or fully automated machines, may give rise to undesired discharges of adhesive occurring, as a result of the adhesive bonding, on the solar-module-laminate front side and/or rear side. Such discharges then usually have to be subjected to laborious manual cleaning. In order to counteract the discharge of adhesives on the laminate front side, it is disclosed, for example in CN104022726A, for the front-side leg to have formed in it at least one adhesive cavity for accommodating adhesive beyond the adhesive-bonding extent, and/or for the front-side-leg end portion to have formed in it at least one adhesive cavity for accommodating adhesive. There is therefore a need to increase the process stability during the operation of framing the solar-module laminate, without high-cost machines with higher levels of adjustment accuracy having to be acquired for this purpose.

### SUMMARY OF THE INVENTION

It is therefore an object of the invention to provide a solar-module frame profile, a solar module and a method of adhesively bonding a solar-module frame profile to a solar-module laminate which ensure better compensation in relation to material tolerances and production tolerances during the operation of fixing frame profiles on a solar-module laminate.

This object is achieved by a solar-module frame profile by a solar module and by a method of adhesively bonding a solar-module frame profile to a solar-module laminate as described in the specification, figures and claims herein.

The invention makes provision for the rear-side leg to extend directly on the frame-groove crosspiece at an obtuse opening angle ranging from 95 to 120 degrees.

In a preferred embodiment, the opening angle directly at the rear-side leg ranges from 95 to 120 degrees and, as the distance from the frame-groove crosspiece increases, the rear-side leg has one or more further opening angles, which increase continuously or in a stepwise manner. The further opening angles here preferably range from 96 to 120 degrees. It is also possible for the further opening angles to exceed a value of 120 degrees.

The solar-module frame profile, in particular the rear-side leg, is thus adapted to the solar-module-laminate geometry. This allows more uniform wetting with adhesive, and a reduction in the quantity of adhesive if the adhesive-wetting level is the same. The legs of the frame groove are designed such that they have a kind of adhesive buffer store. In the case of a front-side leg, this adhesive buffer store is designed in the form of the adhesive cavities known from the prior art and, in the case of the rear-side leg, it is realized by the geometry between the front-side leg and rear-side leg, said geometry widening as the distance from the frame-groove crosspiece increases. Said adhesive buffer stores are suitable for preventing adhesive from exiting on the front side and on the rear side of the solar-module laminate, because it is buffer-stored by the adhesive cavities and by virtue of the rear-side leg being arranged at an obtuse opening angle in relation to the frame-groove crosspiece, and the resulting conical geometry. Since it is possible to prevent the discharge of adhesive onto the solar-module-laminate front side and rear side during the adhesive-bonding operation, there is no need for said front side and rear side to be freed of adhesive once the joining process has taken place. This minimizes, or does away altogether, with the outlay required for cleaning. In addition, the design of the solar-module profile increases the process stability. The obtuse opening angle is selected such that a frame-groove surface of the rear-side leg is adapted to that peripheral region along the edge of the solar-module-laminate rear side which is to be introduced into the frame groove. The thickness of the solar-module laminate usually tapers in the direction of the edge, because the solar cells, which are laminated in and wired to form strings, do not extend as far as the edge of the solar-module laminate. In particular if the solar-module-laminate front side is formed from glass and the solar-module-laminate rear side is formed from a plastic film, arranging the solar cells in the solar-module laminate such that they do not extend as far as the edge results in the front side being of essentially planar design, although the solar-module-laminate rear side, proceeding from peripheral regions to the centre of the solar-module laminate, increases slightly in diameter. During the operation of the solar-module laminate and the solar-module frame profile being pushed one inside the other, the solar-module-laminate front side has its planar surface oriented essentially perpendicularly to the frame-groove crosspiece, whereas the solar-module-laminate rear side forms, in the peripheral region, a surface which runs at a slightly obtuse angle in relation to the frame-groove crosspiece. The obtuse opening angle of the rear-side leg in relation to the frame-groove crosspiece is adapted to this angle formed by the solar-module-laminate rear side in relation to the frame-groove crosspiece. The front-side extent portion is formed perpendicularly, or essentially perpendicularly, to the frame-groove crosspiece preferably in regions in which there is no adhesive cavity, i.e., in the front-side-adhesive-bonding plane, and is therefore likewise adapted to the solar-module-laminate front side, which is of essentially planar design and, during the operation of the solar-module frame profile and solar-module laminate being pushed one inside the other, is likewise oriented perpendicularly to the frame-groove crosspiece. The solar-module frame profile according to the invention is thus adapted to the dimensions of the solar-module laminate, and it is therefore possible to achieve preferably uniform wetting with adhesive between the solar-module laminate and solar-module frame profile during the adhesive-bonding operation. Moreover, this means that only a reduced quantity of adhesive is necessary.

In a preferred embodiment, the obtuse opening angle ranges from 99 to 110 degrees. The one or more further opening angles preferably range from 100 to 120 degrees. The adhesive-bonding extent is preferably less than 1 mm, preferably less than 0.5 mm. Using these values, the solar-module frame profile is adapted optimally to conventional geometries of solar-module laminates.

In a preferred embodiment, proceeding from the frame-groove crosspiece in the direction of the front-side-leg end portion, the front-side-leg extent portion forms the front-side-adhesive-bonding plane over more than 50% of the length of the front-side leg. More preferably, proceeding from the frame-groove crosspiece in the direction of the front-side-leg end portion, the front-side-leg extent portion forms the front-side-adhesive-bonding plane over more than 60%, even more preferably more than 70%, of the length of the front-side leg. This makes it possible to achieve, between the front-side leg and the solar-module-laminate front side which is to be adhesively bonded thereto, an adhesive-bonding surface which is sufficiently large for the mechanical loading which is to be absorbed. It is preferable in this embodiment for the front-side leg to have formed in it, between the front-side-adhesive-bonding plane and the front-side-leg end portion, an adhesive cavity for accommodating adhesive beyond the adhesive-bonding extent. The front-side-adhesive-bonding plane is preferably of planar design, in adaptation to the planar front side of the solar-module laminate.

Proceeding from the frame-groove crosspiece, the rear-side leg preferably forms a rear-side-adhesive-bonding plane over more than 50% of its length. More preferably, proceeding from the frame-groove crosspiece, the rear-side-leg extent portion forms the rear-side-adhesive-bonding plane over more than 60%, even more preferably more than 70%, of the length of the rear-side leg. This makes it possible to provide, between the rear-side leg and the solar-module-laminate rear side which is to be adhesively bonded thereto, an adhesive-bonding surface which is sufficiently large for the mechanical forces which are to be absorbed. In this embodiment, preferably on account of one or more further opening angles of the rear-side leg which are further spaced-apart from the frame-groove crosspiece, the rear-side-adhesive-bonding plane is of non-linear design. It is therefore possible, in the direction of the opening of the frame groove, to perform the function of an adhesive buffer store in the form of the conically widening space between the rear-side leg and the solar-module-laminate rear side which is to be adhesively bonded. This adhesive buffer store is suitable for accommodating adhesive before the latter exits onto the externally visible regions of the solar-module-laminate rear side. This likewise minimizes, or does away altogether, with cleaning-related outlay required for removing the adhesive from the solar-module-laminate rear side. In addition, during the operation of the solar-module laminate and frame profile being pushed one inside the other, the process stability is thus increased, because the adjustment tolerances and dimensional tolerances in relation to the components used are higher.

The solar-module frame profile is advantageously designed such that the rear-side leg has a rear-side-leg end portion, which is spaced apart from the frame-groove crosspiece and is designed in the form of a lip projecting in the direction of the front-side leg. The structure of the rear-side-leg end portion thus constitutes a barrier to adhesive which, during the installation operation, is displaced along the rear-side leg to the rear-side-leg end portion.

In a preferred embodiment, the solar-module frame profile has a cross section which is suitable for production in the form of an extruded component. This makes possible fully automated, and thus cost-effective, production of the solar-module frame profile. The solar-module frame profile is extruded preferably from aluminium or plastics which have long-term weather resistance.

The invention also relates to a solar module having a solar-module laminate and a solar-module frame with solar-module frame profiles according to one or more of the above described embodiments which is adhesively bonded to the solar-module laminate by an adhesive, in the case of which the width of the frame-groove crosspiece in the interior of the frame groove between the front-side leg and rear-side leg of the solar-module frame profile and the opening angle of the rear-side leg are designed such that, along the rear-side leg, the distance between the solar-module laminate and rear-side leg is greater than or equal to the adhesive-bonding extent. On account of these proportions, during the operation of the solar-module laminate and solar-module frame profile being pushed one inside the other, the viscous adhesive will become distributed more quickly between the rear-side leg and the rear side of the solar-module laminate than between the solar-module laminate and the front-side leg.

The invention further relates to a method of adhesively bonding a solar-module frame profile to a solar-module laminate, having the following steps:

providing a solar-module laminate, which has a solar-module-laminate front side;

providing a solar-module frame profile in one or more of the abovedescribed embodiments, wherein the width of the frame-groove crosspiece in the interior of the frame groove between the front-side leg and rear-side leg of the solar-module frame profile and the opening angle of the rear-side leg are designed such that, during the operation, which will be described hereinbelow, of the frame groove and solar-module laminate being pushed one inside the other, the distance between the solar-module laminate and rear-side leg decreases from double the adhesive-bonding extent (K) to no more than the adhesive-bonding extent (K);

applying adhesive, in the interior of the frame groove, to the frame-groove crosspiece;

positioning the front-side-leg end portion on an outer edge of the solar-module-laminate front side; and

pushing the frame groove and solar-module laminate one inside the other parallel to the front-side-adhesive-bonding plane, with the adhesive being partially displaced away from the frame-groove crosspiece in the process, wherein, apart from the front-side-leg end portion, the distance between the solar-module laminate and solar-module frame profile does not drop below a value of 0.5 mm.

The step of providing a solar-module laminate, which has a solar-module-laminate front side, preferably involves the provision of a solar-module laminate with the structure described in the introduction.

Providing a solar-module frame profile in one or more of the above described embodiments preferably involves the provision of the solar-module frame profile in a geometry adapted to the solar-module laminate.

The step of applying adhesive, in the interior of the frame groove, to the frame-groove crosspiece preferably involves the application of silicone. The quantity of adhesive applied is selected such that, within the context of the given adjustment tolerances and dimensional tolerances for the components, the adhesive cannot exit onto the solar-module-laminate front side and rear side during the operation, described hereinbelow, of the frame groove and solar-module laminate being pushed one inside the other.

The steps of positioning the front-side-leg end portion on an outer edge of the solar-module-laminate front side and of pushing the frame groove and solar-module laminate one inside the other parallel to the front-side-adhesive-bonding plane, with the adhesive being partially displaced away from the frame-groove crosspiece in the process, wherein, apart from the front-side-leg end portion, the adhesive-bonding-extent distance between the solar-module laminate and solar-module frame profiles does not drop below a value of 0.5 mm, ensure optimum adhesive bonding of the solar-module laminate and the frame groove. Throughout the solar-module frame profile, the adhesive-bonding extent is preferably at least 0.6 mm and less than 1.5 mm. The method results in a solar module being produced.

Further advantages and properties of the solar-module frame profile, of the solar module and of the method for adhesively bonding the solar-module frame profile to a solar-module laminate will be explained in relation to the prior art with reference to the preferred embodiments described hereinbelow.

The figures however, rather than being depicted to scale, are purely schematic. In addition, the same or similar parts throughout the figures are provided with the same designations.

### BRIEF DESCRIPTION OF THE FIGURES

FIG. 1 shows, schematically, a partial cross-sectional view of a solar-module frame with a solar-module frame profile according to the prior art;

FIG. 2 shows, schematically, a partial cross-sectional view of a solar-module frame with a solar-module frame profile according to the invention; and

FIGS. 3a to 3f show, schematically, a method according to the invention by means of which the solar-module frame with the solar-module frame profile according to the invention shown in FIG. 2 is adhesively bonded to a solar-module laminate.

### DETAILED DESCRIPTION

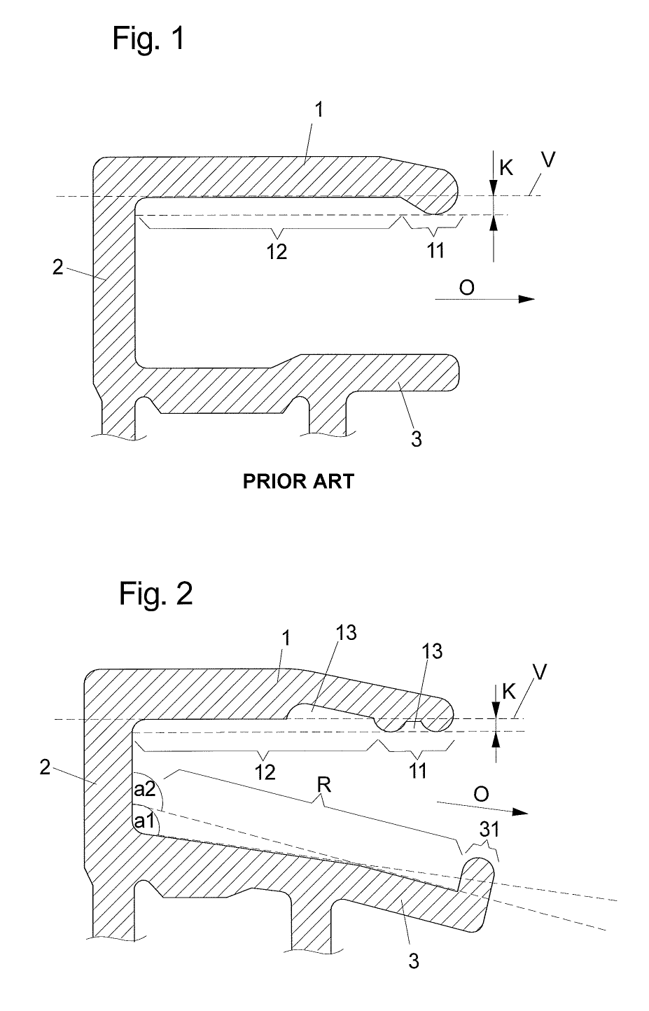

FIG. 1 shows, schematically, a partial cross-sectional view of a solar-module frame profile according to the prior art used on the part of the applicant. This frame profile is described in more detail in the Background section herein.

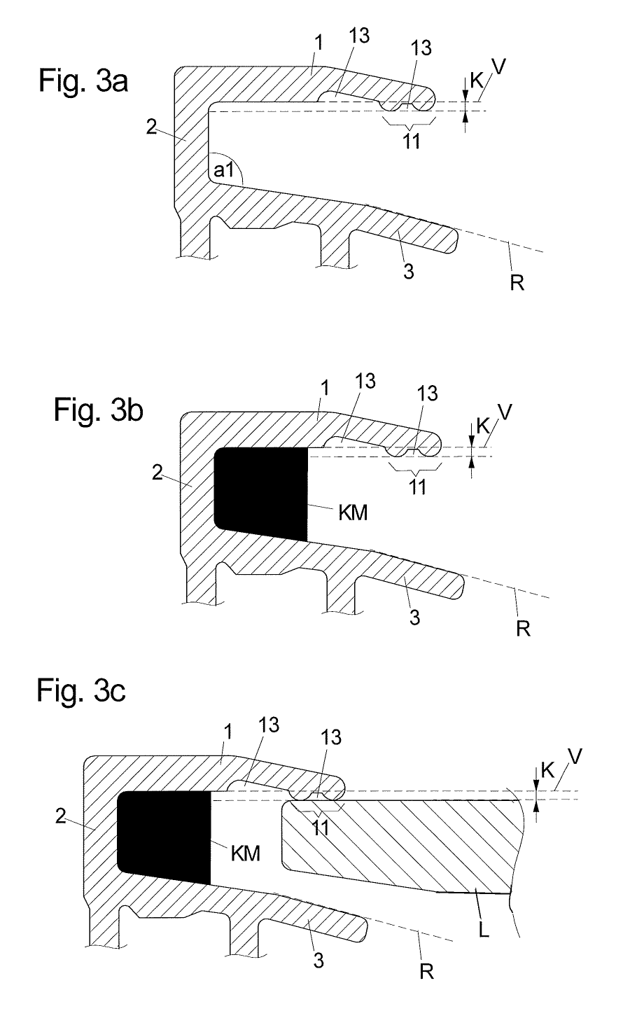

FIG. 2 shows, schematically, a partial cross-sectional view of a solar-module frame profile according to the invention. The solar-module frame profile shown in FIG. 2 corresponds to the solar-module frame profile shown in FIG. 1, but has the following differences therefrom: the front-side leg 1 has formed in it an adhesive cavity 13 for accommodating adhesive (not shown) beyond the adhesive-bonding extent K, the front-side-leg end portion 11 has formed in it a further adhesive cavity 13 for accommodating adhesive (not shown), and the rear-side leg 3 extends directly from the frame-groove crosspiece 2 at an obtuse opening angle a1 ranging from 95 to 120 degrees and, as the distance from the frame-groove crosspiece 2 increases, has a further opening angle a2, which is greater than al.

The adhesive cavity 13 which is formed in the front-side leg 1 beyond the adhesive-bonding extent K is formed in the front-side-leg extent portion 12, which, proceeding from the frame-groove crosspiece 2 in the direction of the front-side-leg end portion 11, makes up the front-side-adhesive-bonding plane V over more than 50% of the length of the front-side leg 1. The front-side-adhesive-bonding plane V is planar, and the adhesive cavity 13 which is adjacent to said plane, and is formed in the front-side leg 1 beyond the adhesive-bonding extent K, is arranged between said plane and the front-side-leg end portion 11. This adhesive cavity 13 can accommodate adhesive (not shown) used during the adhesive-bonding operation. The adhesive cavity 13 which is formed in the front-side-leg end portion 11 is likewise designed to accommodate adhesive (not shown) used during the adhesive-bonding operation.

Proceeding from the frame-groove crosspiece 2, the rear-side leg 3 extends in the first instance at the obtuse opening angle a1 ranging from 95 to 120 degrees, preferably of 99 degrees. After more than half the rear-side-leg length, the opening angle increases into the further opening angle a2, ranging from 109 to 120 degrees. Proceeding from the frame-groove crosspiece 2, the rear-side leg 3 shown in this embodiment forms a rear-side-adhesive-bonding plane R over more than 90% of its length, said plane R being of non-linear design on account of the opening angle a1 increasing in a discontinuous manner to the further opening angle a2 of the rear-side leg 3. The non-linear design of the rear-side leg 3 means that even more adhesive (not shown in this figure) can be accommodated within the frame groove during the operation of adhesively bonding the solar-module frame profile to the solar-module laminate (not shown in this figure). The rear-side leg 3 preferably terminates with a rear-side-leg end portion 31, which projects out of the rear-side-adhesive-bonding plane R in the direction of the front-side leg 1. This rear-side-leg end portion 31 is designed, for example, in the form of a lip by means of which adhesive which, during the installation process, advances in the direction of the rear-side-leg end portion 31 in the form of a barrier which has to be overcome, is prevented from advancing into externally visible regions of the rear side of the solar-module laminate L.

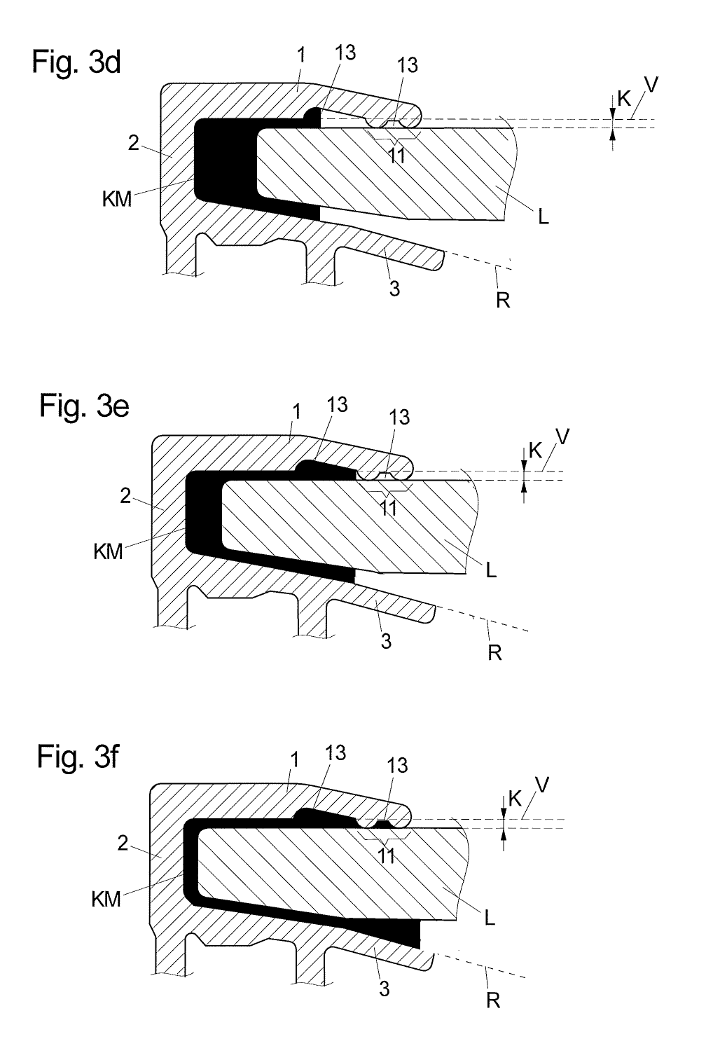

FIGS. 3a to 3f show, schematically, a method according to the invention by means of which a solar-module frame profile according to the invention, similar to that shown in FIG. 2, is adhesively bonded to a solar-module laminate.

FIG. 3a shows the step of providing a solar-module frame profile, which corresponds largely to the solar-module frame profile shown in FIG. 2. The only difference is that the rear-side leg 3 does not have any lip-form rear-side-leg end portion 31 projecting in the direction of the front-side leg 1.

FIG. 3b shows the step of applying adhesive KM, in the interior of the frame groove, to the frame-groove crosspiece 2 of the solar-module frame profile shown in FIG. 3a. FIG. 3c shows the step of positioning the front-side-leg end portion 11 on an outer edge of a solar-module-laminate front side of a solar-module laminate L provided. The solar-module laminate L is oriented here such that its solar-module-laminate front side is parallel to the front-side-adhesive-bonding plane V. FIGS. 3d to 3f illustrate, schematically, the step of the frame groove and solar-module laminate L being pushed one inside the other parallel to the front-side-adhesive-bonding plane V, with the adhesive KM being partially displaced away from the frame-groove crosspiece 2 in the process. Apart from the front-side-leg end portion 11 here, the distance between the solar-module laminate L and solar-module frame profile does not drop below a value of 0.5 mm. As can be seen in FIGS. 3d to 3f, the adhesive KM is partially displaced away from the frame-groove crosspiece 2 as a result of the frame groove and solar-module laminate L being pushed one inside the other, and therefore the adhesive KM is displaced along the front-side leg 1 first of all into the adhesive cavity 13 which is formed in the extent portion 12 of the front-side leg 1, beyond the adhesive-bonding extent K (FIGS. 3d and 3e). If the solar-module laminate and frame profile are moved even further one inside the other, then adhesive is also displaced into the adhesive cavity 13 formed in the front-side-leg end portion 11 (FIG. 3f), wherein it is simultaneously displaced further outwards along the rear-side leg 3 (FIGS. 3d to 3f).

FIGS. 3d, 3e and 3f each illustrate, within the context of the installation process, tolerable arrangements of the solar-module laminate in relation to the frame profile adhesively bonded thereto. Depending on the depth to which the solar-module laminate L has been introduced into the frame groove, there is a change in the distribution of the adhesive KM along the front-side leg 1 and the rear-side leg 3. FIG. 3f shows, in the end portion of the rear-side leg 3, the functionality of the adhesive buffer store by way of a conically widening space between the solar-module laminate L and rear-side leg 3.

### LIST OF DESIGNATIONS

a1 Opening angle
a2 Further opening angle
K Adhesive-bonding extent
KM Adhesive
L Solar-module laminate
O Opening direction
R Rear-side-adhesive-bonding plane
V Front-side-adhesive-bonding plane
1 Front-side leg
11 Front-side-leg end portion
12 Front-side-leg extent portion
13 Adhesive cavity
2 Frame-groove crosspiece
3 Rear-side leg
31 Rear-side-leg end portion

What is claimed is:

1. A solar-module frame profile for framing a solar-module laminate having a solar-module-laminate front side and a solar-module-laminate rear side, wherein the solar-module frame profile has a frame groove which is formed:
from a front-side leg for engaging over the solar-module-laminate front side along a solar-module-laminate edge,
from a rear-side leg for engaging over the solar-module-laminate rear side along the solar-module-laminate edge, and
from a frame-groove crosspiece, which spaces apart the front-side leg and the rear-side leg from one another and from which the front-side leg and the rear-side leg extend away laterally, forming the frame groove in doing so, along an opening direction,
wherein, as seen in a cross section oriented perpendicularly to the plane of the solar-module laminate and along the opening direction, the front-side leg has a front-side-leg end portion, which is spaced apart from the frame-groove crosspiece, and a front-side-leg extent portion, which is arranged between the frame-groove crosspiece and the front-side-leg end portion and defines a front-side-adhesive-bonding plane for adhesively bonding the solar-module frame profile to the solar-module-laminate front side, wherein the front-side-leg end portion projects out of the front-side-adhesive-bonding plane in the direction of the rear-side leg by an adhesive-bonding extent, wherein the front-side leg has formed in it at least one adhesive cavity for accommodating adhesive beyond the adhesive-bonding extent, and/or
the front-side-leg end portion has formed in it at least one adhesive cavity for accommodating adhesive,
wherein the rear-side leg extends directly on the frame-groove crosspiece at an obtuse opening angle ranging from 95 to 120 degrees.

2. The solar-module frame profile according to claim 1, wherein as the distance from the frame-groove crosspiece increases, the rear-side leg has one or more further opening angles, which increase continuously or in a stepwise manner.

3. The solar-module frame profile according to claim 1 wherein, proceeding from the frame-groove crosspiece in the direction of the front-side-leg end portion, the front-side-leg extent portion forms the front-side-adhesive-bonding plane over more than 50% of the length of the front-side leg.

4. The solar-module frame profile according to claim 3, wherein the front-side leg, between the front-side-adhesive-bonding plane and the front-side-leg end portion, forms an adhesive cavity for accommodating adhesive beyond the adhesive-bonding extent.

5. The solar-module frame profile according to claim 1, wherein, proceeding from the frame-groove crosspiece, the rear-side leg forms a rear-side-adhesive-bonding plane over more than 50% of its length.

6. The solar-module frame profile according to claim 1, wherein rear-side leg has a rear-side-leg end portion, which is spaced apart from the frame-groove crosspiece and is defined in the form of a lip projecting in the direction of the front-side leg.

7. The solar-module frame profile according to claim 1, wherein the solar-module frame profile has a cross section which is suitable for production in the form of an extruded component.

8. The solar module having a solar-module laminate and a solar-module frame with the solar-module frame profile according to claim 1 which is adhesively bonded to the solar-module laminate by an adhesive wherein the width of the frame-groove crosspiece in the interior of the frame groove between the front-side leg and rear-side leg of the solar-module frame profile and the opening angle of the rear-side leg are designed such that, along the entire rear-side leg, the distance between solar-module laminate and rear-side leg is greater than or equal to the adhesive-bonding extent.

9. A method of adhesively bonding a solar-module frame profile to a solar-module laminate, having the following steps:
providing a solar-module laminate, which has a solar-module-laminate front side;
providing a solar-module frame profile according to claim 1, wherein the width of the frame-groove crosspiece in the interior of the frame groove between the front-side leg and rear-side leg of the solar-module frame profile and the opening angle of the rear-side leg are designed such that, during the operation, which will be described hereinbelow, of the frame groove and solar-module laminate being pushed one inside the other, the distance between the solar-module laminate and rear-side leg decreases from double the adhesive-bonding extent to no more than the adhesive-bonding extent;
applying adhesive, in the interior of the frame groove, to the frame-groove crosspiece;
positioning the front-side-leg end portion on an outer edge of the solar-module-laminate front side; and
pushing the frame groove and solar-module laminate one inside the other parallel to the front-side-adhesive-bonding plane, with the adhesive being partially displaced away from the frame-groove crosspiece in the process, wherein, apart from the front-side-leg end portion, the distance between the solar-module laminate and solar-module frame profile does not drop below a value of 0.5 mm.
